(19) United States
(12) Patent Application Publication
(10) Pub. No.: US 2011/0175898 A1
(43) Pub. Date: Jul. 21, 2011

(54) DATA INSERTION CIRCUIT OF DISPLAY APPARATUS

(76) Inventors: Yu-Jen Yen, Tainan County (TW); Chien-Ru Chen, Tainan County (TW)

(21) Appl. No.: 12/691,712

(22) Filed: Jan. 21, 2010

(51) Int. Cl. G06F 3/038

(52) U.S. Cl. 345/214

(57) ABSTRACT

A data insertion circuit of a display apparatus includes a signal source, a switch unit and a control unit. The signal source is for providing a video driving signal. The switch unit has an output node coupled to a channel of the display apparatus, a first input node coupled to the signal source, and a second input node coupled to a control voltage for data insertion, and is for selectively outputting the video driving signal or the control voltage to the output node. The control unit is coupled to the switch unit, wherein when the display apparatus is in a normal mode, the control unit controls the switch unit to transmit the video driving signal to the display apparatus; and when the display apparatus is in a data insertion mode, the control unit controls the switch unit to transmit the control voltage to the display apparatus.

### BACKGROUND OF THE INVENTION

1. Field of the Invention

The present invention relates to a data insertion circuit, and more particularly, to a data insertion circuit of a display apparatus.

2. Description of the Prior Art

In a display apparatus, a motion blur technique, which inserts a totally black/grey image between two sequential images in motion, is usually utilized to improve image quality. With the help of this motion blur technique, the images in motion become smoother to the human eye. In a conventional display apparatus, e.g., a liquid crystal display (LCD) panel, motion blur is usually realized at a timing controller (TCON), which serves as an interface between a display module (e.g. a video card) and a display driver. To implement the motion technique, however, the TCON has to operate at a higher frequency to feed data properly to the LCD panel, leading to inefficient power consumption and lowered system efficiency.

### SUMMARY OF THE INVENTION

In light of this, the present invention provides a new data insertion circuit capable of allowing the TCON to operate at a lower frequency and insert motion blur data from an external source. In this way, a better performance can be achieved without major modifications to the system.

According to one embodiment of the present invention, a data insertion circuit of a display apparatus is provided, which includes a signal source, a switch unit and a control unit. The signal source is for providing a video driving signal. The switch unit has an output node coupled to a channel of the display apparatus, a first input node coupled to the signal source, and a second input node coupled to a control voltage for data insertion, and is for selectively outputting the video driving signal or the control voltage to the output node. The control unit is coupled to the switch unit, wherein when the display apparatus is in a normal mode, the control unit controls the switch unit to transmit the video driving signal to the display apparatus; and when the display apparatus is in a data insertion mode, the control unit controls the switch unit to transmit the control voltage to the display apparatus.

According to another embodiment of the present invention, a data insertion circuit of a display apparatus is provided. The insertion circuit includes a first signal source, a second signal source, a first switch unit, a second switch unit, a multiplexer unit and a control unit. The first and the second signal sources provide a first video driving signal and a second video signal, respectively. The first switch unit has an output node, a first input node coupled to the first signal source, and a second input node coupled to a first control voltage for data insertion, and is for selectively outputting the first video driving signal or the first control voltage to the output node of the first switch unit. The second switch unit has an output node, a first input node coupled to the second signal source, and a second input node coupled to a second control voltage for data insertion, for selectively outputting the second video driving signal or the second control voltage to the output node of the second switch unit, wherein a voltage level of the first control voltage is different from a voltage level of the second control voltage. The multiplexer unit has a first input node coupled to the output node of the first switch unit, a second input node coupled to the output node of the second switch unit, a first output node coupled to a first channel of the display apparatus, and a second output node coupled to a second channel of the display apparatus. When the display apparatus is in a normal mode, the control unit controls the first switch unit to transmit the first video driving signal to the multiplexer unit, controls the second switch unit to transmit the second video driving signal to the multiplexer unit, and controls the multiplexer unit to output the first video driving signal and the second video driving signal to the first channel and the second channel of the display apparatus, respectively; and when the display apparatus is in a data insertion mode, the control unit controls the first switch unit to transmit the first control voltage to the multiplexer unit, controls the second switch unit to transmit the second control voltage to the multiplexer unit; and controls the multiplexer unit to alternately output the first control voltage and the second control voltage to the first channel and the second channel of the display apparatus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a data insertion circuit of a display apparatus according to an embodiment of the present invention.

FIG. 2 is a schematic diagram of a type-1 data insertion circuit of a display apparatus according to an embodiment of the present invention.

FIG. 3 is a schematic diagram of a type-2 data insertion circuit of a display apparatus according to another embodiment of the present invention.

FIG. 4 is a schematic diagram of a data insertion circuit of a display apparatus according to an embodiment of the present invention.

FIG. 5 is a schematic diagram of a two-channel data insertion circuit of a display apparatus according to an embodiment of the present invention.

FIG. 6 is a schematic diagram of a two-channel data insertion circuit of a display apparatus according to another embodiment of the present invention.

FIG. 7 is a timing diagram of signals when inserting an all grey image via a data insertion circuit in FIG. 6 according to an embodiment of the present invention.

FIG. 8 is a schematic diagram of a two-channel data insertion circuit of a display apparatus according to another embodiment of the present invention.

### DETAILED DESCRIPTION

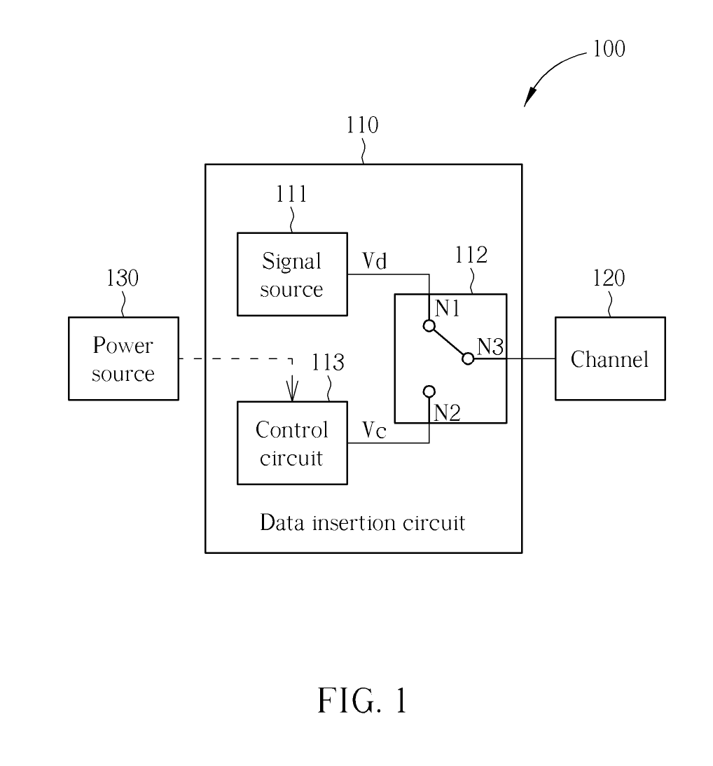

Please refer to FIG. 1, which is a schematic diagram of a data insertion circuit 110 of a display apparatus 100 according to an embodiment of the present invention. The data insertion circuit 110 has a signal source 111, a switch unit 112 and a control unit 113. The signal source 111 provides a video driving signal Vd to the switch unit 112. The switch unit 112 has an output node N3 coupled to a channel 120 of the display apparatus 100, a first input node N1 coupled to the signal source 111, and a second input node N2 coupled to a control voltage Vc generated from the control unit 113 for data insertion, and is for selectively outputting the video driving signal Vd or the control voltage Vc to the output node N3. Please note that the channel 120 can be one of an even channel or an odd channel of a specific pixel on the display apparatus 100, e.g., an even channel of a specific pixel on a display panel. When the display apparatus 100 is in a normal mode, the control unit 113 controls the switch unit 112 to transmit the video driving signal Vd to the display apparatus 100; and when the display apparatus 100 is in a data insertion mode, the control unit 113 controls the switch unit 112 to transmit the control voltage Vc to the display apparatus 100.

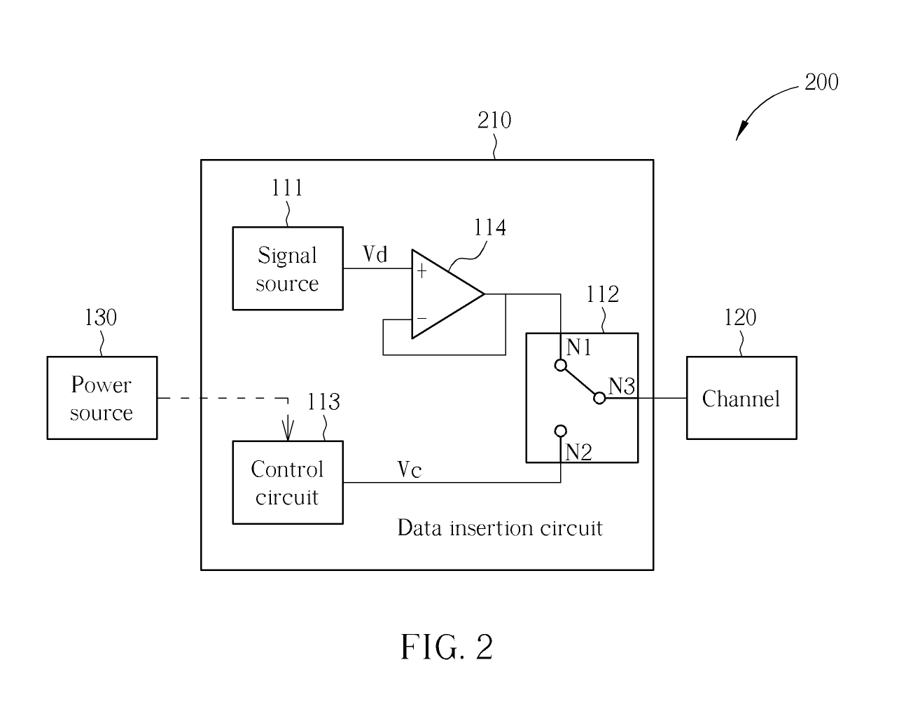

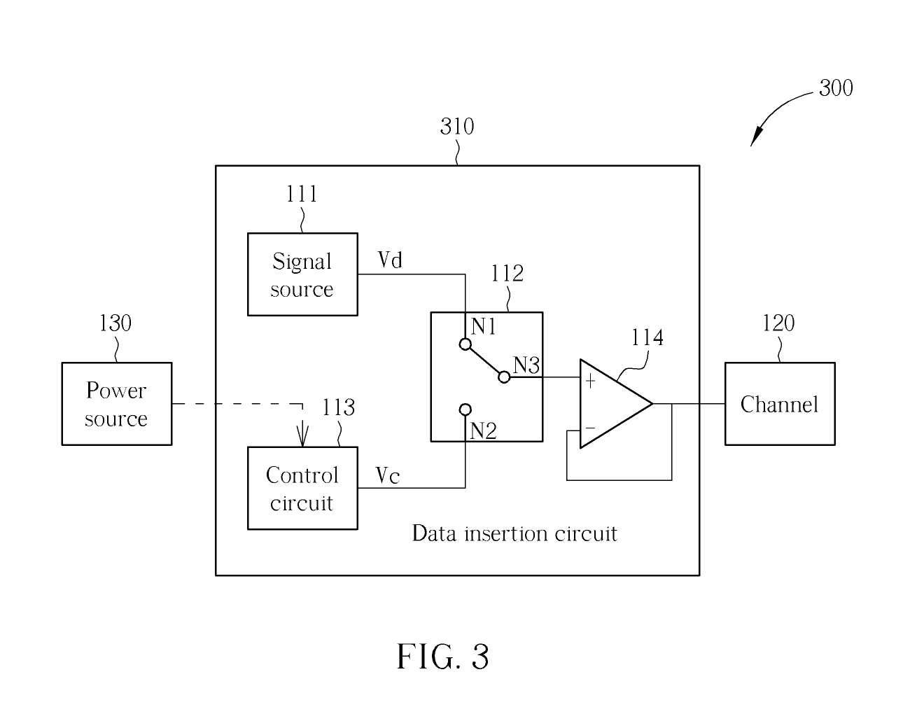

In a practical implementation, however, a data insertion circuit usually requires an interface to facilitate driving a channel of a display apparatus. Therefore, the switch unit introduced in the present invention also requires a buffer to enhance its driving ability to transmit image data. To be more specific, the data insertion circuit disclosed here can be categorized into two major types. Please refer to FIG. 2 and FIG. 3 in conjunction with FIG. 1. FIG. 2 is a schematic diagram of a type-1 data insertion circuit 210 of the display apparatus 200 according to an embodiment of the present invention, and FIG. 3 is a schematic diagram of a type-2 data insertion circuit 310 of the display apparatus 300 according to another embodiment of the present invention. In FIG. 2, an additional buffer (e.g., an operational amplifier with negative feedback) 114 is introduced between the switch unit 112 and the signal source 111 for driving the channel 120. In this example, when the display apparatus 200 is in the normal mode, the control unit 113 controls the switch unit 112 to transmit the video driving signal Vd via the buffer 114 and the channel 120 sequentially to the display apparatus. When the display apparatus 200 is in the data insertion mode, the control unit 113 controls the switch unit 112 to transmit the control voltage Vc to the display apparatus 200, and during the data insertion mode, the output terminal of the buffer 114 sees a high-impedance loading.

In FIG. 3, the additional buffer 114 of a data insertion circuit 310 is located between the switch unit 112 and the channel 120 of a display apparatus 300. In this example, when the display apparatus 300 is in the normal mode, the control unit 113 controls the switch unit 112 to transmit the video driving signal Vd via the buffer 114 and the channel 120 sequentially to the display apparatus. When the display apparatus 300 is in the data insertion mode, the control unit 113 controls the switch unit 112 to transmit the control voltage Vc to the display apparatus 300 via the buffer 114 and the channel 120 sequentially to the display apparatus 300, and during the data insertion mode, the output terminal of the signal source 111 sees an open-circuited loading.

Please note that the control voltage Vc provided by the control unit 113, which can be a fixed supply voltage (e.g., a time-invariant voltage) from the display apparatus 100, 200 or 300, a common voltage (VCOM) of the display apparatus 100, 200 or 300, or an external voltage at arbitrary level which can be provided by a power source 130 external to the data insertion circuit 110, 210, or 310, can be designed according to different requirements. By way of example, for a normally white/black LCD panel, when a totally black image is to be inserted, the control voltage Vc can be derived from a supply voltage, a reference ground or a common voltage of the display apparatus 200 or 300 via the control unit 113, and when an arbitrary grey image is to be inserted, a common voltage of the display apparatus 100, 200 or 300 plus a modification voltage can be provided via the control unit 113.

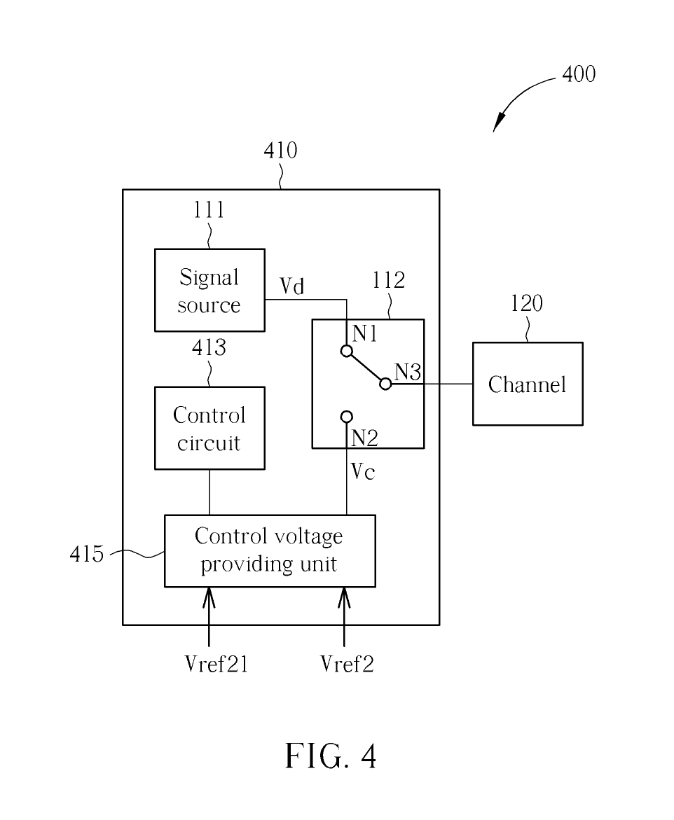

When a constant voltage is consistently put on a channel of a pixel within a display panel, the display panel may become less sensitive to voltage variation, leading to a malfunction resulting in a shortened lifetime of the display panel. Therefore, when inserting an all black image/arbitrary grey image, some modification should be made for the applied voltage to protect the display. Please refer to FIG. 4, which is a schematic diagram of a data insertion circuit of a display apparatus according to another embodiment of the present invention. Compared with the architecture in FIG. 1, the data insertion circuit 410 of the display apparatus 400 includes an additional control voltage providing unit 415. The control voltage providing unit 415 is coupled to the switch unit 112 and the control unit 413, and is for receiving a first reference voltage Vref1 and a second reference voltage Vref2. When the display apparatus 400 is in the data insertion mode, the control unit 413 controls the control voltage providing unit 415 to alternately output the first reference voltage Vref1 and the second reference voltage Vref2 as the control voltage Vc. For example, the first reference voltage Vref1 and the second reference voltage Vref2 can be VCM0+VDIFF0 and VCM0−VDIFF0, respectively, wherein VCM0 is a common voltage of the display apparatus 400 and VDIFF0 is an arbitrary non-zero voltage, so by applying these two voltage to the channel 120, an arbitrary grey image can be inserted without damaging the display apparatus 400.

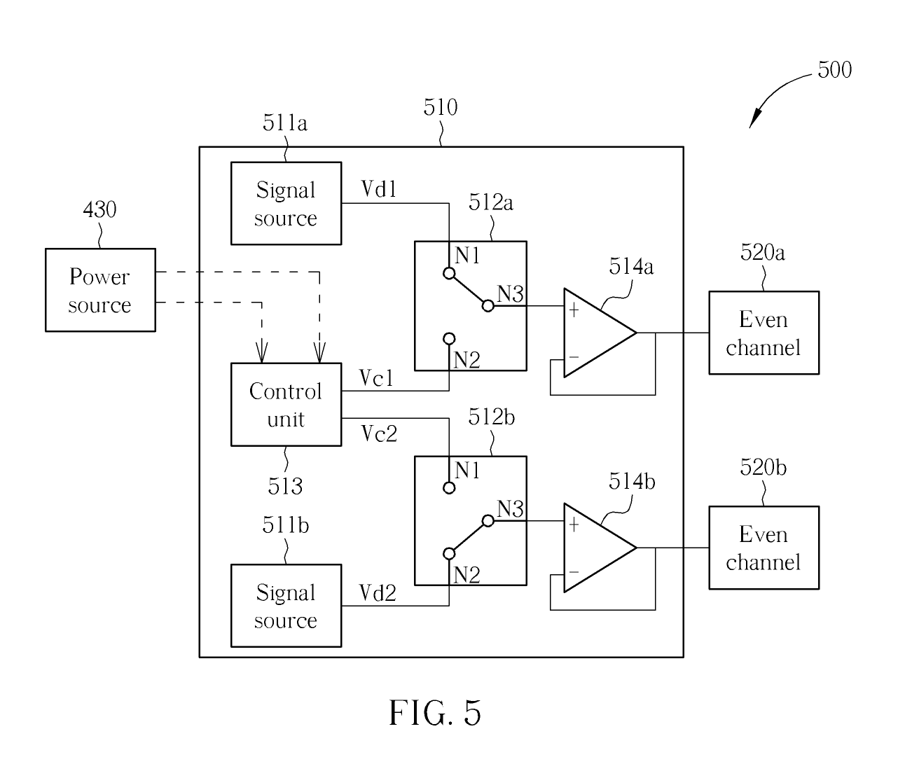

In a practical display apparatus, e.g., an LCD panel, each pixel on the LCD panel is driven through a pair of channels, i.e., an even channel and an odd channel. For a normally-white LCD panel, during the data insertion mode, one of the even channel and the odd channel must be driven by the supply voltage while the other of the even channel and the odd channel must be driven by the reference ground. For an example of this, please refer to FIG. 5, which is a schematic diagram of a two-channel data insertion circuit 510 of a display apparatus 500 according to an embodiment of the present invention. When the display apparatus 500 is in the normal mode, the control unit 513 controls the switch units 512a and 512b to transmit the video driving signals Vd1 and Vd2 respectively generated from signal sources 511a and 511b via the buffers 514a and 514b to an even channel 520a and an odd channel 520b, respectively. When the display apparatus 500 is in the data insertion mode, the control unit 513 controls the switch units 512a and 512b to transmit the control voltages Vc1 and Vc2 to the display apparatus 500 via the buffers 514a and 414b to the even channel 520a and the odd channel 520b, respectively.

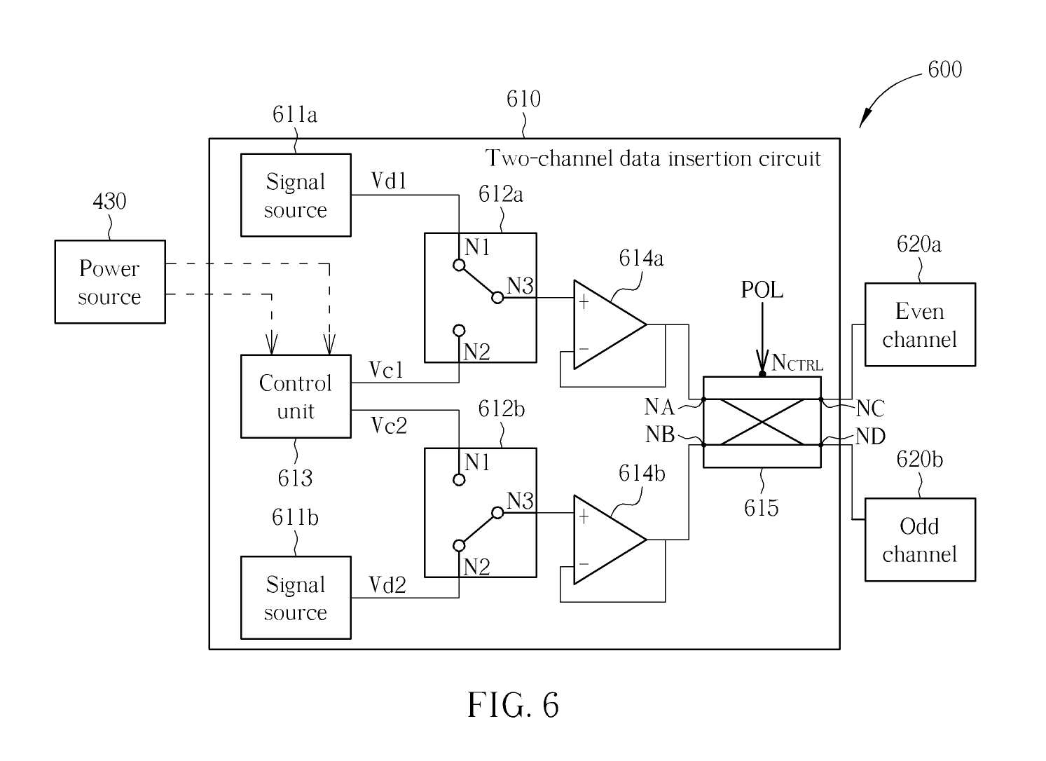

A constant voltage difference at the even channel and odd channel may cause damage and thus a shortened lifetime of the display panel 500. In light of this, the present invention further provides a method to elongate the lifetime of the display panel 400. Please refer to FIG. 6 for further illustration. FIG. 6 is a schematic diagram of a two-channel data insertion circuit 610 of a display apparatus 600 according to another embodiment of the present invention. Some components of the display apparatus 600 are quite similar to corresponding components of the display apparatus 500, and further description is therefore omitted here for brevity. It can be seen that an additional multiplexer unit 615 is introduced. In this embodiment, the multiplexer unit 615 has a control node N_{CTRL} for receiving a control signal POL, a first input node NA coupled to the output node of the switch unit 612a via the buffer 614a, a second input node NB coupled to the output node of the switch unit 612b via the buffer 614b, a first output node NC coupled to the even channel 620a of the display apparatus 600, and a second output node ND coupled to the odd channel 620b of the display apparatus 600, and is for alternately outputting the control voltage Vc1 and second control voltage Vc2 to the even channel 620a and the odd channel 620b of the display apparatus 600 according to the control signal POL.

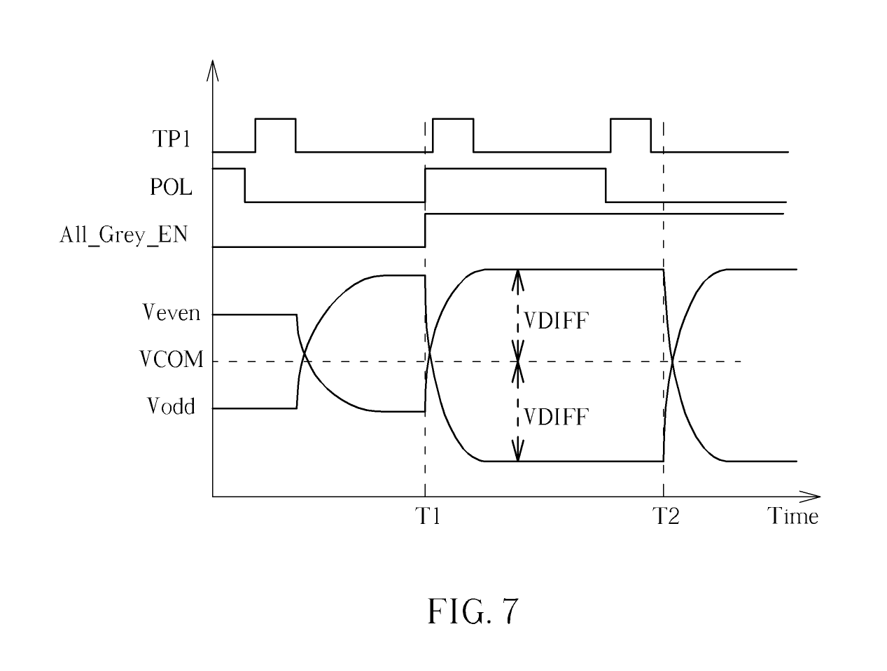

Please refer to FIG. 7 for a detailed operation of the data insertion circuit 610 in FIG. 6. FIG. 7 is a timing diagram of signals when inserting an all grey image via the data insertion circuit 610 in FIG. 6 according to an embodiment of the present invention, wherein a signal TP is a system clock of the data insertion circuit 610, All_grey_EN is a signal to trigger the control unit 613, VCOM is a common voltage of the display apparatus 600, Veven and Vodd are signals received by the even channel 620a and the odd channel 620b, respectively. Before a timing point T1, the display apparatus 600 is in the normal mode, the even channel 120a and the odd channel 120b receive signals from signal sources 611a and 611b, respectively, and the multiplexer unit 615 is equivalently transparent in the normal mode. When the display apparatus 500 enters the data insertion mode, signal All_grey_EN rises up, forcing the switch units 612a and 612b to deliver signals from control unit 613 to the multiplexer unit 615. Since an arbitrary grey image is inserted, the control unit 613 delivers voltage VCOM±VDIFF to the multiplexer unit 615, wherein VDIFF is an adjustable signal which indicates the grey level of the inserted grey image. At the timing point T2, the multiplexer unit 615 senses a falling edge of the system clock TP1 and detects that the control signal POL has changed its sign, and the multiplexer unit 615 thereby switches its output. In this way, an all grey image insertion can be successfully accomplished without damaging the lifetime of the display apparatus 600.

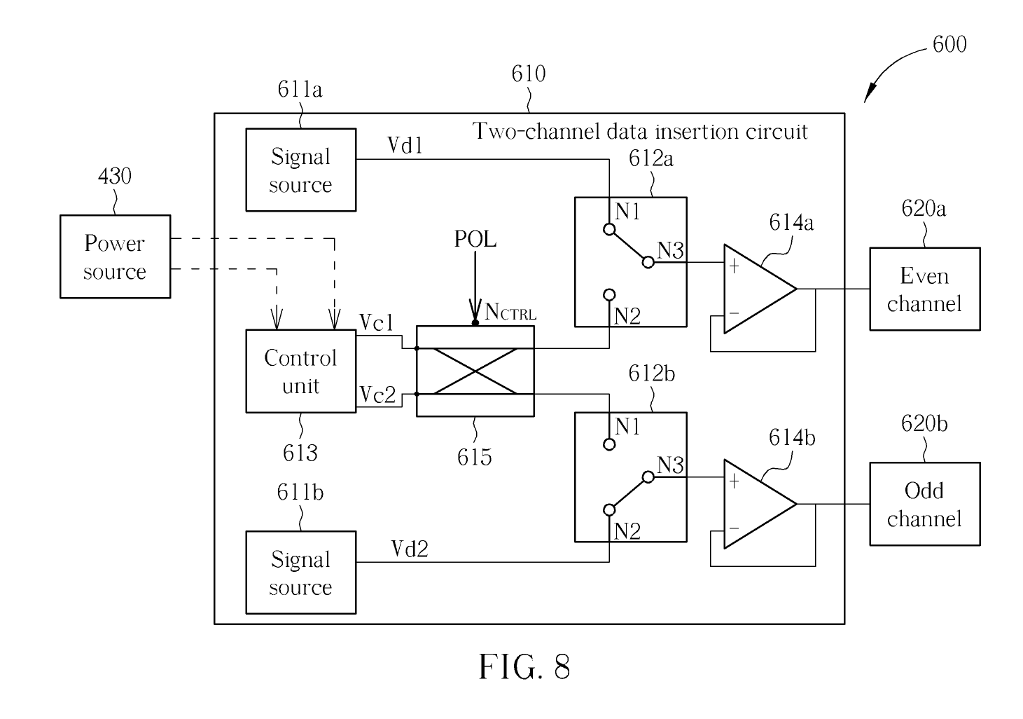

It should be noted that the architecture in FIG. 6 is only for illustrative purposes, and is not supposed to be a limitation to the present invention. For example, the multiplexer unit 615 can also be placed between the control unit 613 and switch units 612a and 612b as shown in FIG. 8. This kind of variation in design still falls within the scope of the present invention.

To summarize, the present invention provides a data insertion apparatus capable of inserting motion blur data from an external source without signification modification to architecture. In this way, a timing controller of the display can consume fewer system resources and a better performance can be achieved.

Those skilled in the art will readily observe that numerous modifications and alterations of the device and method may be made while retaining the teachings of the invention.

What is claimed is:

1. A data insertion circuit of a display apparatus, comprising:
a signal source, for providing a video driving signal;
a switch unit, having an output node coupled to a channel of the display apparatus, a first input node coupled to the signal source, and a second input node coupled to a control voltage for data insertion, for selectively outputting the video driving signal or the control voltage to the output node; and
a control unit, coupled to the switch unit, wherein:
when the display apparatus is in a normal mode, the control unit controls the switch unit to transmit the video driving signal to the display apparatus; and
when the display apparatus is in a data insertion mode, the control unit controls the switch unit to transmit the control voltage to the display apparatus.

2. The data insertion circuit of claim 1, wherein the control voltage is a time-invariant voltage.

3. The data insertion circuit of claim 2, further comprising:
a buffer, coupled between the output node of the switch unit and the channel of the display apparatus.

4. The data insertion circuit of claim 2, wherein the control voltage is provided from the display apparatus.

5. The data insertion circuit of claim 4, wherein the display apparatus is a liquid crystal display (LCD) panel, and the control voltage is a common voltage (VCOM) of the LCD panel.

6. The data insertion circuit of claim 2, further comprising:
a power source, external to the display apparatus, for providing the control voltage.

7. The data insertion circuit of claim 1, further comprising:
a control voltage providing unit, coupled to the switch unit and the control unit, for receiving a first reference voltage and a second reference voltage;
wherein when the display apparatus is in the data insertion mode, the control unit controls the control voltage providing unit to alternately output the first reference voltage and the second reference voltage as the control voltage.

8. The data insertion circuit of claim 7, further comprising:
a buffer, coupled between the first input node of the switch unit and the signal source.

9. The data insertion circuit of claim 7, further comprising:
a buffer, coupled between the output node of the switch unit and the channel of the display apparatus.

10. The data insertion circuit of claim 7, wherein the first reference voltage and the second reference voltage are provided from the display apparatus.

11. The data insertion circuit of claim 10, wherein the display apparatus is a liquid crystal display (LCD) panel, the first reference voltage is a global supply voltage of the LCD panel, and the second reference voltage is a global ground voltage of the LCD panel.

12. The data insertion circuit of claim 10, wherein the display apparatus is a liquid crystal display (LCD) panel, the first reference voltage is between a global supply voltage and a common voltage (VCOM) of the LCD panel, and the second reference voltage is between a global ground voltage and the common voltage of the LCD panel.

13. The data insertion circuit of claim 7, further comprising:
a power source, external to the display apparatus, for providing the first reference voltage and the second reference voltage.

14. A data insertion circuit of a display apparatus, comprising:
a first signal source, for providing a first video driving signal;
a second signal source, for providing a second video driving signal;
a first switch unit, having an output node, a first input node coupled to the first signal source, and a second input node coupled to a first control voltage for data insertion, for selectively outputting the first video driving signal or the first control voltage to the output node of the first switch unit;
a second switch unit, having an output node, a first input node coupled to the second signal source, and a second input node coupled to a second control voltage for data insertion, for selectively outputting the second video driving signal or the second control voltage to the output node of the second switch unit, wherein a voltage level of the first control voltage is different from a voltage level of the second control voltage;
a multiplexer unit, having a control node for receiving a control signal, a first input node coupled to the output node of the first switch unit, a second input node coupled to the output node of the second switch unit, a first output node coupled to a first channel of the display apparatus, and a second output node coupled to a second channel of the display apparatus, for alternately outputting the first control voltage and the second control voltage to the first channel and the second channel of the display apparatus according to the control signal; and
a control unit, coupled to the first switch unit, the second switch unit, and the multiplexer unit, wherein:
when the display apparatus is in a normal mode, the control unit controls the first switch unit to transmit the first video driving signal to the multiplexer unit, controls the second switch unit to transmit the second video driving signal to the multiplexer unit, and controls the multiplexer unit to output the first video driving signal and the second video driving signal to the first channel and the second channel of the display apparatus, respectively; and
when the display apparatus is in a data insertion mode, the control unit controls the first switch unit to transmit the first control voltage to the multiplexer unit, and controls the second switch unit to transmit the second control voltage to the multiplexer unit.

15. The data insertion circuit of claim 14, further comprising:
a first buffer, coupled between the output node of the first switch unit and the first input node of the multiplexer unit; and
a second buffer, coupled between the output node of the second switch unit and the second input node of the multiplexer unit.

16. The data insertion circuit of claim 14, wherein the display apparatus is a liquid crystal display (LCD) panel, the first control voltage is a global supply voltage of the LCD panel, and the second control voltage is a global ground voltage of the LCD panel.

17. The data insertion circuit of claim 14, wherein the display apparatus is a liquid crystal display (LCD) panel, the first control voltage is between a global supply voltage and a common voltage (VCOM) of the LCD panel, and the second control voltage is between a global ground voltage and the common voltage of the LCD panel.
